(19) United States
(12) Patent Application Publication
(10) Pub. No.: US 2026/0160922 A1
(43) Pub. Date: Jun. 11, 2026

(54) SYSTEMS AND METHODS FOR AI-DRIVEN WEATHER PREDICTION AND MODIFICATION

(71) Applicant: Atmo, Inc., San Francisco, CA (US)

(72) Inventors: Johan MATHE, San Francisco, CA (US); Alexander LEVY, San Francisco, CA (US); Oleksandr SVIRIDENKO, San Francisco, CA (US); Thomas Crutcher DUNNAVANT, JR., San Francisco, CA (US)

(21) Appl. No.: 19/408,914

(22) Filed: Dec. 4, 2025

Related U.S. Application Data
(60) Provisional application No. 63/729,356, filed on Dec. 7, 2024.
(60) Provisional application No. 63/729,370, filed on Dec. 7, 2024.

(51) Int. Cl. G01W 1/10; G06N 20/20

(52) U.S. Cl. CPC G01W 1/10; G06N 20/20; G01W 2203/00

(57) ABSTRACT

Systems and methods applicable, for instance, to AI-driven weather prediction and modification. Early detection and prediction functionality can perform actions including using deep learning models to identify emerging cyclonic systems, and using ensemble-based prediction frameworks to generate potential trajectory scenarios. Further, multi-scale modeling functionality can perform actions including combining models operating at different physical scales. Also, intervention optimization functionality can perform actions including applying reinforcement learning models to intervention strategy optimization, and employing differential evolution algorithms to identify atmospheric intervention points. Additionally, physical intervention functionality for atmospheric modification can involve actions including activating machine learning models when an atmospheric threat is detected, running counterfactual what-if ensembles for various candidate intervention classes, and evaluating rewards.

### CROSS-REFERENCE TO RELATED APPLICATIONS

This application claims priority to: a) U.S. Provisional Patent Application Ser. No. 63/729,356, filed on Dec. 7, 2024; and b) U.S. Provisional Patent Application Ser. No. 63/729,370, filed on Dec. 7, 2024. The disclosures of these Applications are herein incorporated by reference in their entirety and for all purposes.

### FIELD

The present disclosure relates generally to the field of machine learning, and more specifically, but not exclusively, to systems and methods for AI-driven weather prediction and modification.

### BACKGROUND

Tropical cyclones, including hurricanes, pose catastrophic threats to human life, property, and infrastructure, resulting in billions of dollars in damage annually. Conventional prediction and mitigation strategies for tropical cyclones suffer from several significant limitations.

For example, according to conventional approaches, physical intervention techniques—such as cloud seeding, marine cloud brightening, and stratospheric aerosol injection—are typically applied without precise targeting or optimal timing. This limitation is, in part, a consequence of the lack of speed and/or granularity in traditional modeling approaches, which are unable to, for instance, identify optimal intervention points with sufficient accuracy.

As another example, traditional modeling approaches typically lack the speed and/or granularity (e.g., spatial/temporal resolution) called for to identify and/or evaluate intervention points (e.g., optimal intervention points). For instance, the complexity of solving numerical weather prediction (NWP) and classical models typically increases rapidly with resolution—often proportional to the cube of the resolution—making high-resolution and/or long-horizon forecasts computationally intractable. This deficiency can impact both the targeting of interventions and the ability to provide timely and actionable early warnings.

As a further example, the massive energy scales involved in tropical cyclones (e.g., fully formed tropical cyclones) typically render direct suppression impractical. For instance, existing brute-force methods are typically unable to alter (or meaningfully alter) storm intensity and/or trajectory once a cyclone has matured. As an additional example, conventional early warning systems often fail to provide sufficient lead time for effective preventive action. This deficiency can be a consequence of the limited speed and/or granularity of traditional modeling approaches, which typically delay detection and/or reduce the window for meaningful intervention.

As another example, current methods cannot reliably influence tropical cyclone trajectory and/or intensity in a controlled manner. In an aspect, the inherent complexity of atmospheric systems, combined with the computational limitations of conventional models, typically prevents the precise and/or timely identification of intervention strategies (e.g., intervention strategies that can achieve desired outcomes without unintended consequences), according to existing approaches.

In view of at least the foregoing, a need exists for improved systems and methods for AI-driven weather prediction and modification in an effort to overcome the aforementioned obstacles and deficiencies of conventional approaches. Various aspects will now be discussed in greater detail.

### BRIEF DESCRIPTION OF THE DRAWINGS

FIG. 1 is a diagram depicting example software modules for weather prediction and/or modification, according to various embodiments.

FIG. 2 is a diagram depicting example submodules of an early detection and prediction software module, according to various embodiments.

FIG. 3 is a diagram depicting example submodules of a multi-scale modeling software module, according to various embodiments.

FIG. 4 is a diagram depicting example submodules of an intervention optimization software module, according to various embodiments.

FIG. 5 is a diagram depicting example submodules of a physical intervention software module, according to various embodiments.

FIG. 6 shows an example configuration for weather sensing, prediction, and/or modification, according to various embodiments.

FIG. 7 shows an example computer, according to various embodiments.

It should be noted that the figures are not drawn to scale, and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION

Extreme weather events such as tropical cyclones (e.g., hurricanes) have historically caused immense human and economic loss. For example, the devastation wrought by Hurricane Katrina highlighted the stakes involved—billions of dollars in damage, countless lives disrupted, and critical infrastructure compromised.

Over the decades, scientists have explored a range of intervention strategies, from cloud seeding to more speculative concepts (e.g., the use of nuclear weapons), in an effort to weaken and/or redirect tropical cyclones. But the vast energy of these storms has rendered direct, brute-force methods impractical. However, the approaches discussed herein can, in an aspect, build upon the chaos theory notion that small, well-timed interventions can have outsized effects on the evolution of complex systems. Rather than relying on overwhelming force, utilizing the functionality discussed herein subtle and/or early modifications to atmospheric conditions can have the potential to be sufficient to prevent tropical cyclones from reaching catastrophic intensity.

The system can, in an aspect, use AI-based weather modeling approaches that operate at speeds orders of magnitude faster than those of traditional techniques. These improved approaches can achieve high resolution (e.g., high spatial and/or temporal resolution) and/or improved accuracy compared to existing approaches (e.g., 100× higher resolution and/or 2× accuracy), thereby, for instance, enabling the system to simulate of scenarios for entire regions in near-real time.

For example, the system can be used to generate precise models for specific geographic areas (e.g., the San Francisco Bay Area), supporting hyper-local predictions, and can be scaled to larger regions, such as those that experience frequent severe weather events (e.g., the Philippines, where 22 typhoons strike each year). With this computational speed and flexibility, the system can, for instance, evaluate not just a most likely future, but a range of possible futures, allowing, for instance, for the testing of intervention strategies (e.g., before critical thresholds are reached).

In various embodiments, the system can use adjoint models and/or autodifferentiation. For example, the system can use adjoint models to enable efficient computation of how small changes in initial conditions and/or intervention parameters affect final outcomes. As another example, the system can use autodifferentiation frameworks to allow the system to compute derivatives with respect to a wide range of variables, revealing, for instance how a given input variable—such as humidity, temperature, and/or aerosol concentration—can influence storm intensity and/or trajectory.

Further, as just some examples the system can: a) use reinforcement learning agents to test a multitude of intervention strategies; b) use scenario planning systems to evaluate interventions (e.g., under uncertainty); and/or c) use closed-loop learning processes to support continuous improvement of decisions. Also, in various embodiments the system can, as just some examples, use constraint satisfaction techniques to ensure that selected interventions do not violate regulations, worsen weather in other regions, and/or cause unintended ecological impacts. By quantifying the relative value and impact of each potential action, the system can, for instance, support the selection of effective and/or low-risk interventions.

The functionality discussed herein can, in various embodiments, be used to generate tailored intervention strategies for atmospheric modification. For example, the system can support interventions such as marine cloud brightening, aerosol injections, bubble curtains, and/or other approaches to achieve outcomes such as altering heat and/or moisture distribution. The system can identify placement (e.g., optimal placement), timing, and/or quantity for these interventions, such as guided by reinforcement learning and/or scenario planning. Further, as atmospheric conditions evolve the system can use approaches such as closed-loop feedback to adjust strategies (e.g., adjust strategies in real time). Where, for example, the system determines a given approach to be unsatisfactory, the system can test alternative scenarios. In this way, benefits including supporting continuous refinement and/or improvement can be realized.

From an economic perspective, the system can provide benefits for a range of stakeholders, including insurers, governments, and/or property owners. The cost of targeted interventions according to the approaches discussed herein can typically be lower (e.g., significantly lower) than the costs associated with property damage and/or human suffering resulting from severe weather events. As such, the use of the system discussed herein can be considered to be economically rational, as preventing disasters is often less costly and/or more humane than post-event recovery and/or rebuilding.

The functionality discussed herein can be applied to regions of varying sizes (e.g., to the San Francisco Bay Area and/or to the Philippines). Further, the functionality can be applied on a global scale. Also, in various embodiments there can be coordination with various parties—including governmental leaders and/or agencies, insurance firms, and/or humanitarian organizations—to systematically reduce the impact of tropical cyclones and other severe weather events worldwide.

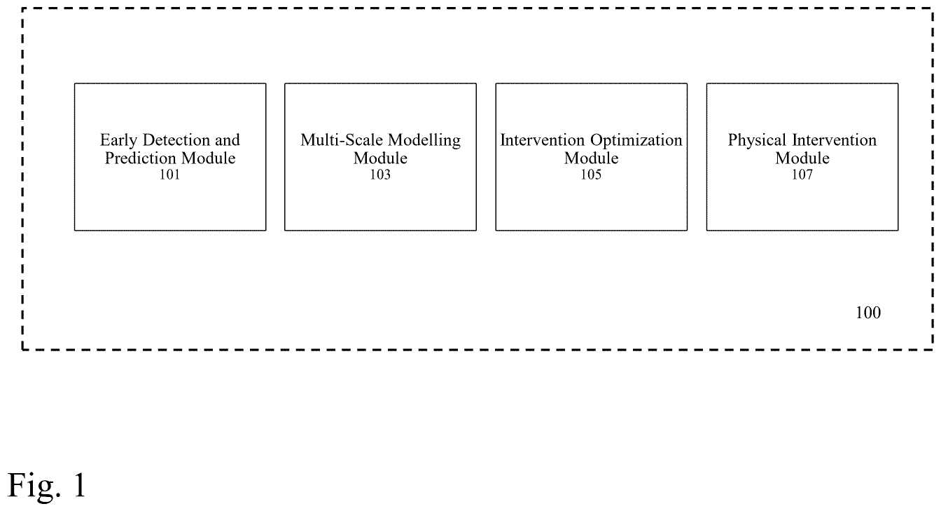

By integrating various approaches (e.g., deep learning, adjoint modeling, and/or optimized intervention), the functionality discussed herein can yield multiple benefits, including enabling a shift from passive forecasting to active prevention and/or mitigation of severe weather impacts. Turning to FIG. 1, in various embodiments the system 100 discussed herein can use one or more software modules, such as early detection and prediction module 101, multi-scale modeling module 103, intervention optimization module 105, and/or physical intervention module 107.

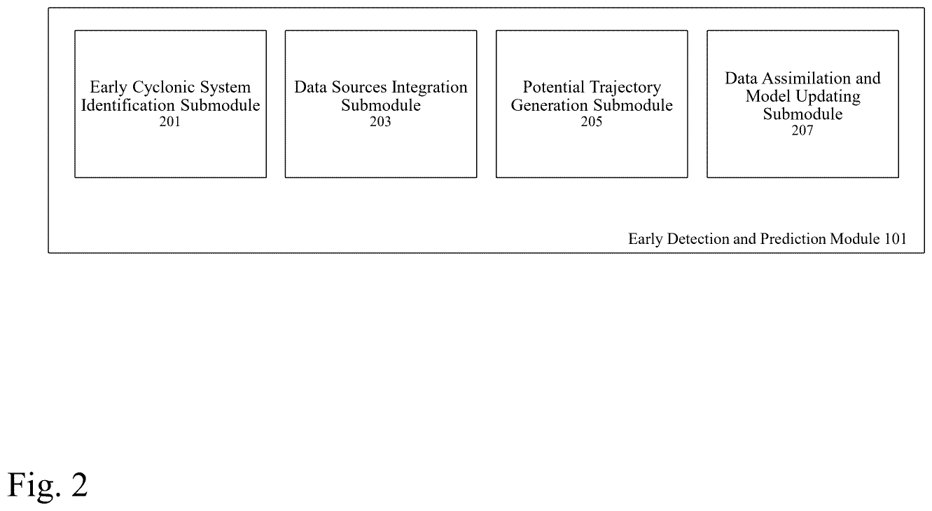

According to various embodiments, the system can implement early detection and prediction functionality. For example, this early detection and prediction functionality can be implemented using software modules and/or submodules such as those depicted by FIG. 2, where early detection and prediction module 101 is shown to include early cyclonic system identification submodule 201, data sources integration submodule 203, potential trajectory generation submodule 205, and data assimilation and model updating submodule 207. The functionality can, for instance, leverage advanced deep learning models to identify emerging cyclonic systems (e.g., at their earliest stages). Here, for example, the system can use early cyclonic system identification submodule 201. The early detection and prediction functionality can integrate a wide range of data sources, including satellite observations, radar measurements, ocean buoy data, and/or ground-based stations. Here, for example, the system can use data sources integration submodule 203. In this way the system can, for example, provide a comprehensive view of atmospheric conditions. Ensemble-based machine learning model prediction frameworks can, in various embodiments, be used to generate a multitude of potential trajectory scenarios (e.g., hundreds of potential trajectory scenarios). Here, for example, the system can use potential trajectory generation submodule 205.

The system can also perform real-time data assimilation and/or model updating. Here, for example, the system can use data assimilation and model updating submodule 207. In an aspect, the system can take initial atmospheric conditions (e.g., current atmospheric conditions) and/or sensor data (e.g., from radar, satellite, radiosondes, and/or ground stations) as inputs, and apply machine learning models (e.g., deep learning models) to, for example, generate predicted forecasts. The approaches used by the system to generate the forecasts can include auto-regressive and parametric time (e.g., jump-to-horizon) approaches.

The system can employ a multitude of modeling paradigms. For example, neural operators (e.g., Fourier neural operators, graph neural operators, DeepONet, vision transformers adapted for operator learning, and/or diffusion models adapted for operator learning) can be used for purposes including fluid dynamics modeling. As another example, the system can employ diffusion models, such as to provide for probabilistic weather pattern evolution (e.g., to allow the system to simulate how weather patterns change over time). In various embodiments, the diffusion models employed by the system can update their internal representations of weather as new data (e.g., observations) arrives, and/or the application of diffusion models by the system can pose forecasting as a denoising problem. According to this denoising pose, an initial “noisy” state can be iteratively refined by the model to yield a weather prediction.

The system can, as a further example, employ cascade models, such as to address multi-scale and/or longer-term atmospheric dynamics. As just an illustration, each stage of the cascade can focus on a different scale (e.g., micro, meso, or synoptic) and/or aspect of the atmosphere. As further examples the system can employ: a) physics-informed neural networks (PINNs) (e.g., for constraint satisfaction); b) chemistry-coupled atmospheric models (e.g., to simulate aerosol interactions); c) Lagrangian particle models (e.g., for intervention tracking); d) coupled ocean-atmosphere models (e.g., for energy exchange); and/or e) radiation transfer models (e.g., for thermal dynamics).

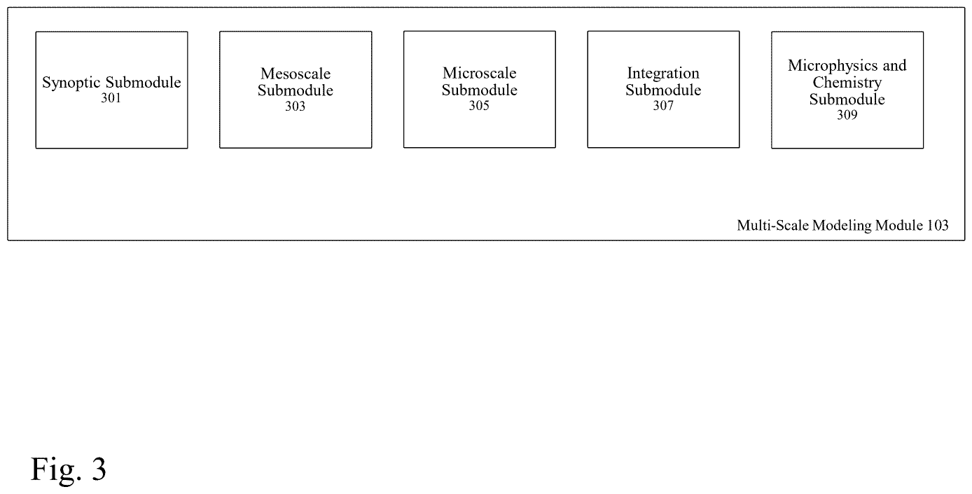

According to various embodiments, the system can implement a multi-scale modeling framework. For example, this multi-scale modeling framework can be implemented using software modules and/or submodules such as those depicted by FIG. 3, where multi-scale modeling module 103 is shown to include synoptic submodule 301, mesoscale submodule 303, microscale submodule 305, integration submodule 307, and microphysics and chemistry submodule 309. The multi-scale modeling framework can, for instance, combine models operating at different physical scales in order to provide enhanced capabilities for atmospheric analysis and/or intervention planning. As just some examples: a) synoptic scale atmospheric models can be used to represent global weather patterns (e.g., using synoptic submodule 301); b) mesoscale models can be used to capture regional dynamics (e.g., using mesoscale submodule 303); and/or c) microscale models can be employed (e.g., using microscale submodule 305) for physics (e.g., detailed physics) relevant to various interventions.

An integration layer can, in various embodiments, be employed to combine outputs from multiple modeling scales. Here, for example, the system can use integration submodule 307. Also, a hybrid architecture that incorporates both traditional models (e.g., traditional computational fluid dynamics (CFD) models) and AI-based models can, in various embodiments, be used. According to this hybrid architecture, some or all computationally intensive traditional models (e.g., CFD parameterizations) can be replaced by the system with, for example, neural operators such as of the sort discussed earlier. As just an illustration, coarse global models can be implemented using classical CFD approaches, while high-resolution models can be implemented via neural operators. In this way, benefits including improving computational efficiency and/or flexibility can be realized.

The system can also implement microphysics and/or chemistry modeling approaches. Here, for example, the system can use microphysics and chemistry submodule 309. These approaches can regard: a) cloud nucleation and/or droplet formation dynamics; b) moisture content and/or phase transition modeling; c) deep convection and/or vertical mixing; d) eye wall formation and/or stability analysis; e) boundary layer interactions; f) precipitation efficiency modeling; g) aerosol-cloud interaction physics; and/or h) condensation and/or evaporation kinetics. In various embodiments, these microphysics and chemistry modeling approaches can be implemented via AI-based surrogate models, and/or be implemented such that conventional approaches are accelerated using surrogate models. The surrogate models can, for example, be trained using: a) data obtained from conventional physics simulations (e.g., high-fidelity conventional physics simulations); and/or b) data obtained from observation.

As an example of such use of surrogate models for microphysics and chemistry modeling, cloud nucleation and/or droplet formation can be emulated using neural operator models (e.g., neural operator models of the sort discussed herein) that learn activation and/or growth dynamics (e.g., from κ-Köhler microphysics). In this way, benefits including enabling real-time prediction of droplet spectra without solving full bin and/or parcel equations can be realized. As another example of such use of surrogate models, moisture content and phase transitions can be approximated by PINNs that learn thermodynamic relationships in the Maxwell-Mason framework, thereby enforcing conservation laws while bypassing iterative numerical solvers. As a further example of such use of surrogate models, deep convection and vertical mixing can be modeled using transformer-based spatiotemporal networks that, for instance, leverage attention mechanisms to model both spatial and temporal dependencies in data. These transformer-based spatiotemporal networks can, as just an illustration, be trained on large-eddy simulation output. In this way, various benefits can be realized, including capturing turbulent transport and/or entrainment processes at a lower computational cost (e.g., at a significantly lower computational cost) than traditional approaches.

As an additional example of the use of surrogate models, eye wall formation and/or stability analysis can employ graph-based AI models (GNNs) that that replicate, as just some examples, vortex structure, potential vorticity evolution, and/or energy transfer patterns. In these GNNs, nodes can represent entities or variables (e.g., vortex elements and/or energy reservoirs), and edges can represent relationships or interactions (e.g., energy transfer and/or physical coupling between regions). Using surrogate models for eye wall formation and/or stability analysis can provide various benefits including enabling rapid sensitivity analysis for control optimization. As a further example of the use of surrogate models, boundary layer interactions can be represented by hybrid AI-physics models that infer surface fluxes and/or turbulence profiles from environmental inputs (e.g., directly from environmental inputs), thereby, for instance, replacing traditional Monin-Obukhov and ocean coupling schemes. As an additional example of the use of surrogate models, precipitation efficiency can be predicted using diffusion models and/or probabilistic neural networks (PNNs). These diffusion models and/or PNNs can, for instance, be trained on ensemble microphysics outputs, and/or can learn coalescence and/or sedimentation behavior under various thermodynamic regimes.

As a further example of the use of surrogate models, aerosol-cloud interactions can be simulated using deep generative models (e.g., decoder-only transformers and/or diffusion models). These models can predict, for instance, aerosol activation, aging, and/or cloud albedo effects (e.g., without explicitly tracking particles). And, as another example of the use of surrogate models, condensation and/or evaporation kinetics can be modeled using differentiable neural surrogates (e.g., PINs and/or decoder-only transformers). These differentiable neural surrogates can be trained, for instance, to reproduce diffusion-limited growth and/or phase-change behavior. In this way, as just an example, rapid gradient-based optimization of intervention parameters within the overall control framework can be realized.

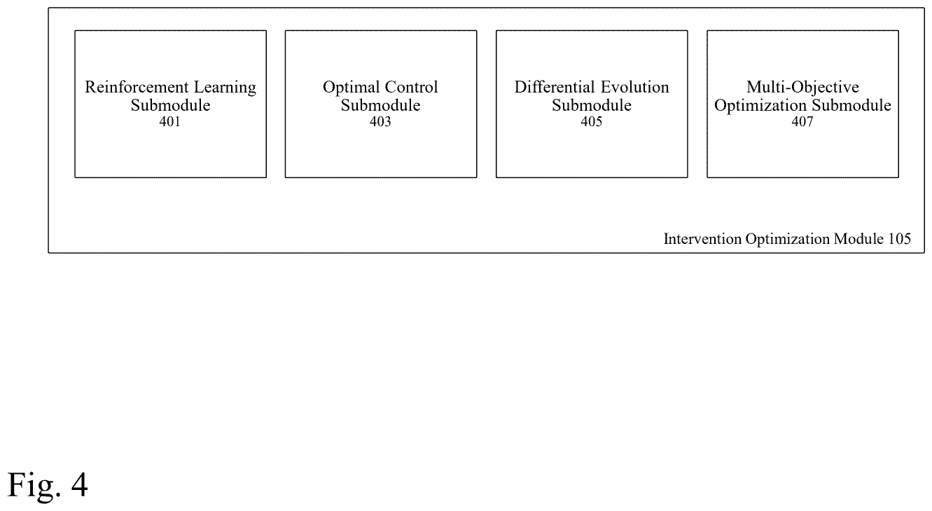

According to various embodiments, the system can perform intervention optimization operations. For example, these intervention optimization operations can be implemented using software modules and/or submodules such as those depicted by FIG. 4, where intervention optimization module 105 is shown to include reinforcement learning submodule 401, optimal control submodule 403, differential evolution submodule 405, and multi-objective optimization submodule 407. These intervention optimization operations can include using reinforcement learning (RL) models for intervention strategy optimization (e.g., via reinforcement learning submodule 401), and/or using differential evolution (DE) to identify atmospheric intervention points (e.g., via differential evolution submodule 405). These intervention optimization operations can also include using approaches from optimal control theory (e.g., via optimal control submodule 403), and/or using multi-objective optimization approaches (e.g., via multi-objective optimization submodule 407).

For example, RL models can be integrated within an AI-driven simulation loop, thereby enabling the system to, for instance, continuously learn how and/or where to apply modifications (e.g., minimal, targeted modifications) to atmospheric conditions, such as to reduce tropical cyclone (e.g., hurricane) impacts. The RL framework can, for example, operate on top of differentiable surrogate models (e.g., neural operators and/or PINNs) that emulate the dynamics of conventional full numerical weather prediction (NWP) systems (or other conventional weather prediction systems) at a lower computational cost (e.g., a significantly lower computational cost) than those conventional systems. These surrogate models can provide the environment for a corresponding RL agent, thereby allowing the system to conduct various what-if experiments (e.g., rapid and/or parallelized what-if experiments).

The RL agent can be trained to minimize one or more metrics, such as storm intensity, central pressure, and/or landfall probability, subject to physical and/or regulatory constraints. In this regard, the system can employ model-based and/or model-free RL approaches (e.g., the system can employ a combination of model-based and model-free RL approaches). For example, model-based RL methods (e.g., differentiable model predictive control (MPC) and/or deep deterministic policy gradient (DDPG) with embedded adjoint sensitivities) can leverage the differentiability of surrogate models to compute gradients of storm outcomes with respect to various intervention variables (e.g., aerosol concentration, release timing, and/or injection altitude). These gradients, which can be derived using approaches including adjoint modeling and/or automatic differentiation (AD), can enable the system to, for example, identify regions, times, and/or microphysical parameters that are sensitive to perturbations (e.g., that are most sensitive to small perturbations). The system can use this information to focus interventions where they are likely to be most effective.

In, for instance, parallel, policy optimization techniques such as Proximal Policy Optimization (PPO) and/or Soft Actor-Critic (SAC) can be used to train agents that generalize across scenarios and/or uncertainties. These agents can explore the intervention parameter space by: a) sampling actions (e.g., actions including adjusting aerosol injection rates and/or adjusting marine cloud brightening intensity); and b) receiving feedback based on predicted storm behavior from the surrogate model ensemble. In various embodiments, to accelerate convergence the system can compute adjoint-based sensitivity maps and/or gradient saliency fields from the surrogate models, and these maps and/or fields can be used by the system to guide the exploration process. In particular, such guidance can steer the RL agent toward meteorologically sensitive zones (e.g., emerging convection cells and/or nascent eyewall structures).

A hybrid optimization loop can, in various embodiments, be used by the system to combine adjoint-derived gradients for local refinement with RL-driven exploration for global search. The adjoint system can provide rapid gradients (i.e., first-order sensitivities) of macro-scale outcomes with respect to small-scale variables, thereby indicating, for example, how small changes in input parameters can influence the overall system behavior. The RL policy network can integrate these results over time to form intervention strategies (e.g., adaptive, long-term intervention strategies). Additionally, multi-agent reinforcement learning (MARL) architectures can be used for various purposes including coordinating multiple intervention assets (e.g., aircraft, drones, and/or ships). Here, a given agent can learn cooperative behaviors under shared reward structures that represent system-wide storm modification goals.

By, in various embodiments, including differentiable surrogate models, adjoint solvers, and/or RL agents within the same computational loop, the system can achieve benefits including closed-loop optimization. In this way, the system can simulate, evaluate, and/or adapt intervention plans in near-real time, and/or can refine (e.g., continuously refine) its control policy as new atmospheric data is assimilated. This approach can provide benefits including enabling the system to rapidly identify effective (e.g., the most effective) intervention points—such as both spatially and temporally—while considering cost, energy use, and/or environmental risk.

The system can, in various embodiments, employ additional optimization techniques. For example, approaches from optimal control theory can be used by the system for parameter and/or plan tuning, supporting the identification of intervention strategies that optimize desired outcomes subject to relevant constraints. As another example, DE algorithms can be applied by the system to identify atmospheric intervention points (e.g., high-impact atmospheric intervention points), such as specific regions, altitudes, and/or times where small and/or targeted (e.g., precisely targeted) perturbations can yield increased influence (e.g., the greatest influence) on storm trajectory, intensity, and/or structure. Where DE is used, the employed DE algorithm can, in various embodiments, operate within an optimization framework that couples multi-scale numerical weather models with AI-based surrogate models. A given candidate solution in the DE population can represent a potential intervention plan, for example being defined by a vector of parameters such as aerosol injection coordinates, timing windows, particle composition, concentration, and/or delivery altitude. The DE algorithm can evolve these candidate solutions iteratively, using mutation, crossover, and/or selection operators guided by a fitness function (e.g., a fitness function derived from predicted storm outcomes).

The fitness function can, in various embodiments, evaluate multiple objectives simultaneously. These multiple objectives can include: a) reductions in maximum wind speed and/or central pressure; b) changes in storm track probability distribution; and/or c) minimization of unintended downstream effects. These objectives can be computed in multiple ways. For example, the objectives can be computed (e.g., rapidly computed) using differentiable surrogate models such as those previously discussed (e.g., neural operators and/or PINNs can be used). The differentiable surrogate models can be used by the system to, for instance, emulate tropical cyclone dynamics (e.g., full-physics tropical cyclone dynamics). In this way, various benefits can be realized, including allowing DE iterations (e.g., each DE iteration) to explore possible intervention configurations (e.g., a large number of possible intervention configurations), such as in near real time.

The system can, in various embodiments, focus search efficiency. For example, the system can use sensitivity maps (e.g., adjoint-derived sensitivity maps generated by the surrogate and/or numerical model) to identify atmospheric regions (e.g., high-impact atmospheric regions) that can serve as initial candidate domains for the DE population. These atmospheric regions can, as just some examples, include zones of strong vorticity gradients, latent heat release, and/or moisture convergence. The DE algorithm can subsequently evolve intervention parameters within those zones (e.g., by refining location and/or magnitude through successive generations).

DE can, in various embodiments, operate in tandem with reinforcement learning agents. For example: a) the DE algorithm can perform global exploration across the intervention space; and/or b) the RL agent can fine-tune local actions. Such fine-tuning can, for instance, be performed in near real time and/or when new data is assimilated. Also, in various embodiments adaptive mutation rates and/or crossover probabilities can be guided by uncertainty estimates (e.g., uncertainty estimates from ensemble forecasts). In this way the system can, for instance, bias exploration toward regions of high forecast sensitivity.

The outcome of the DE process can, in various embodiments, be a ranked set of optimized intervention strategies. Each such intervention strategy can, as just an illustration, specify when, where, and/or how to deploy various modification assets (e.g., aircraft, ships, and/or drones) in order to achieve one or more goals specified by the system (e.g., reduction in storm intensity and/or potential for storm redirection). These goals can be subject to various constraints such as physical, environmental, and/or safety constraints. More generally, the intervention optimization functionality of the system can employ multi-objective optimization approaches that consider effectiveness, cost, and/or risk, thereby offering benefits including supporting robust and adaptive decision-making for atmospheric intervention planning.

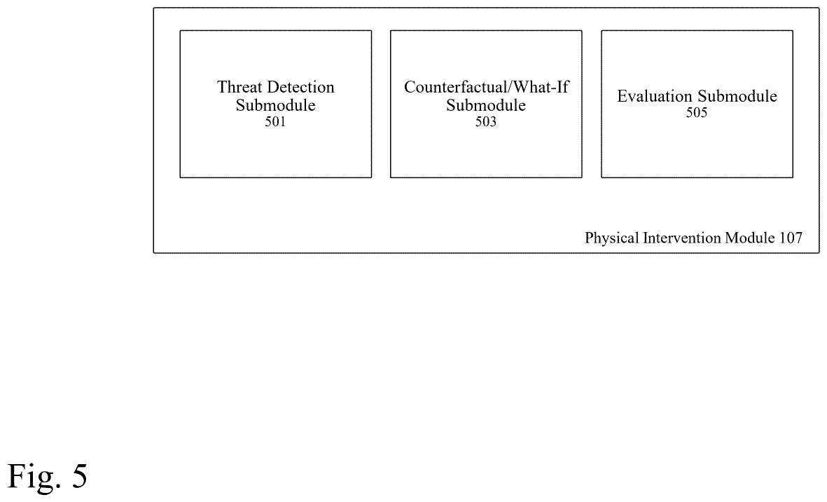

According to various embodiments, the system can implement a range of physical intervention technologies for atmospheric modification. For example, these physical intervention technologies can be implemented using software modules and/or submodules such as those depicted by FIG. 5, where physical intervention module 107 is shown to include threat detection submodule 501, counterfactual/what-if submodule 503, and evaluation submodule 505. These technologies can include: a) cloud seeding approaches (e.g., advanced cloud seeding approaches with precise delivery mechanisms); b) marine cloud brightening (e.g., marine cloud brightening with optimized particle distribution); c) stratospheric aerosol injection (e.g., stratospheric aerosol injection with controlled dispersion); d) intervention approaches that are formulated by the system using simulation insights; and/or e) automated delivery systems for intervention deployment (e.g., drones, aircraft, and/or ships).

When an atmospheric threat (e.g., a pre-formation tropical depression and/or a rapidly intensifying tropical cyclone) is detected, the system can activate one or more models. Here, for instance, the system can use threat detection submodule 501. The system can, for example, activate a multi-scale ensemble of fast deep learning surrogate models (e.g., neural operators and/or PINNs), such as models that are calibrated to high-fidelity conventional weather prediction and/or CFD simulations. For a given candidate intervention class (e.g., cloud seeding, marine cloud brightening (MCB), stratospheric aerosol injection (SAI), and/or simulation-derived methods), the system can run counterfactual what-if machine learning model ensembles (e.g., ensembles that use the fast deep learning surrogate models) that vary intervention-specific control parameters (e.g., particle number flux, mode diameter, release altitude, footprint, and/or cadence). Here, for example, the system can use counterfactual/what-if submodule 503. The system can subsequently evaluate multi-objective rewards (or other rewards). Here, for example, the system can use evaluation submodule 505. These rewards can include: a) changes in storm intensity and/or track; b) landfall risk; c) rainfall redistribution; d) downwind impact; e) cost; f) logistics, and/or g) regulatory and/or safety constraints.

Adjoint sensitivities and/or saliency maps (e.g., as generated by differentiable surrogate models) can be used by the system to, for example, identify high-leverage spatial and/or temporal domains (e.g., incipient eyewall shear zones, moisture convergence lines, and/or boundary-layer enthalpy hot spots). These domains can be used by the system to seed a candidate set. A global search process (e.g., DE and/or Bayesian optimization with expected improvement) can be used to prune low-yield options from the candidate set. Further, the system can apply optimization (e.g., robust optimization) to favor interventions that achieve effectiveness that satisfy system-selected parameters (e.g., interventions that remain effective across a range of model and/or initial-condition perturbations). In considering interventions, the system can utilize various approaches, such as ensemble spread and/or risk metrics (e.g., Conditional Value at Risk (CvaR)).

In various embodiments, where the system finds that multiple intervention classes perform well, it can perform operations such as: a) composing a hybrid plan (e.g., MCB preconditioning followed by targeted seeding); and/or b) verifying logistical considerations (e.g., platform range, sortie count, maritime deconfliction and/or airspace deconfliction). Subsequently, the system can generate one or more recommendations (e.g., one or more ranked recommendations selected by the system from the Pareto front).

For an intervention class selected by the system, the system can generate a control vector (e.g., a control vector with physically meaningful bounds). This control vector can include variables such as: a) agent type (e.g., hygroscopic and/or spray material class); b) size distribution (e.g., geometric mean diameter and/or geometric standard deviation); c) number and/or mass flux; d) release altitude and/or column; e) horizontal footprint and/or pattern; f) timing window and/or cadence; g) platform mix (e.g., drones, aircraft, and/or ships); and/or h) delivery kinematics (e.g., airspeed, track spacing).

In various embodiments, parameterization of intervention plans can proceed in one or more system loops. For example, the parameterization can proceed in three loops (e.g., three nested loops): a) a gradient loop; b) a global loop; and c) a sequential loop. In the gradient loop, the system can use approaches applied to a given surrogate model to obtain gradients of objectives with respect to control variables (d(objective)/d(control)). These approaches can include adjoint differentiation and/or automatic differentiation. In this way, the system can, for example, achieve fast gradient-based refinement around candidate seeds. In the global loop, the system can ensure broad exploration of the parameter space by, for example, using: a) DE (e.g., involving mutation and crossover over coordinates, rates, and/or sizes); and/or b) Bayesian optimization. These approaches can, for example, be guided by uncertainty estimates from the model ensemble. Then, in the sequential loop, the system can apply approaches such as differentiable MPC and/or reinforcement learning (e.g., PPO and/or SAC) to schedule deployments over time. Further, in various embodiments receding-horizon re-planning can be performed by the system as new observations (e.g., from radar, satellite, and/or buoys) are assimilated (e.g., into the surrogate and/or conventional model state).

Hard constraints can be enforced, for instance, via differentiable penalties and/or projection. As just some examples, these hard constraints can include: a) thermodynamic and/or chemical budgets; b) mass and/or energy conservation; c) no-go geographic zones; d) environmental thresholds; and/or e) aircraft performance. Soft preferences can be handled, for instance, via scalarization and/or lexicographic ordering. As just some examples, these soft preferences can include: a) cost; b) sortie count; and/or c) equity of risk.

The output of these procedures can be an operations-level intervention plan. This operations-level intervention plan can, for example, specify: a) agent class and/or purity; b) target number flux (e.g., in particles/(m²·s)); c) mass rate (e.g., as mass rate (kg/s)); d) mode diameter and/or spread; e) release altitude band; f) geospatial pattern (e.g., waypoints, legs, and/or spacing); g) start times, stop times, and/or intervals; and/or h) platform allocation per leg. During execution, streaming measurements can, in various embodiments, drive closed-loop updates. Where observed effects diverge from those that were forecasted by the system, the system can (e.g., via MPC and/or RL) in various embodiments adjust factors including dosage, footprint, and/or timing. The adjustments can, for example, be made within bounds that have been selected by the system (e.g., within pre-approved bounds). Further where observed effects diverge from those that were forecasted, the system can, in various embodiments, trigger a safe abort (e.g., a safe abort according to risk management protocols).

According to various embodiments, the system can implement a multi-scale model integration framework that combines models operating at different physical scales, such as synoptic, mesoscale, and/or microscale. These models can be combined through, as just some examples, hierarchical, hybrid, and/or dynamically coupled frameworks that allow data, constraints, and/or higher-level information to flow bidirectionally between scales. Integration across scales can be achieved in a variety of ways, including but not limited to the following approaches.

According to a first such approach, hierarchical coupling can be used. Here, larger-scale models (e.g., synoptic and/or global models) can provide boundary and/or initial conditions to finer-scale models (e.g., mesoscale and/or microscale models). Outputs from the synoptic and/or global model (e.g., pressure gradients, temperature fields, and/or wind shear) can be used to constrain the simulation domain of regional and/or local models. Aggregated feedback from finer scales (e.g., local convection intensity, cloud microphysics, and/or surface heat fluxes) can be periodically upscaled and/or reintroduced into the parent model to, for example, improve accuracy. This bidirectional information flow can be implemented using techniques such as: a) adaptive coupling intervals; and/or b) real-time feedback mechanisms (e.g., real-time feedback mechanisms based on machine learning error correction).

A second such approach can be a nesting approach. Here, one or more local models (e.g., high-resolution local models) can be nested within a parent (e.g., a coarser parent domain associated with a parent model). A given nested domain can inherit time-varying boundary conditions from the corresponding parent, and can operate at a higher temporal and/or spatial resolution than the parent. The system can, in various embodiments, dynamically adjust nesting levels in response to one or more factors (e.g., detected storm development). In this way, various benefits can be realized, including: a) allowing for automatic refinement of resolution in areas of interest (e.g., forming eyewall regions); and b) enabling early detection functionality to transition seamlessly, for instance, from large-scale pattern recognition to localized intervention simulation.

According to a third such approach, hybrid AI-physics integration can be used. For example, AI-based neural operator models (e.g., Fourier neural operators, graph neural operators, and/or vision transformers adapted for operator learning) can be used by the system to learn coupling relationships between scales from multi-scale simulation data (e.g., directly from multi-scale simulation data). As just some examples, traditional CFD and/or NWP models can be used to simulate the underlying physics, while AI-based surrogates can approximate various cross-scale transfer functions (e.g., energy flux across scales, momentum exchange between layers, and/or moisture and/or latent heat redistribution). The learned operators can accelerate various computations (e.g., coupling computations), thereby yielding benefits including providing near real-time model updates suitable for reinforcement learning-driven intervention control loops.

According to a fourth such approach, multi-fidelity data assimilation can be used. For example, this approach can be employed by the system to integrate observational data (e.g., from satellites, buoys, and/or radar) into multiple scales (e.g., into multiple scales simultaneously), such as using ensemble Kalman filters and/or variational methods (e.g., 3D-Var and/or 4D-Var). AI-based data fusion modules can, in various embodiments, reconcile discrepancies between scales, such as by adjusting mesoscale humidity fields to maintain global mass balance, and/or by ensuring that microscale aerosol concentration fields remain consistent with macro-scale circulation patterns. Here, as an example benefit, a given model layer can be informed by raw observation and/or the state of adjacent scales.

According to a fifth such approach, dynamic scale bridging via RL can be used. Here, an RL agent can determine, for instance, when and/or how to activate finer-scale models. The decision can be based on indicators such as convective instability and/or cyclonic vorticity thresholds. The RL system can, as just an example, treat the multi-scale model ensemble as an adaptive hierarchy, such as by activating, weighting, and/or deactivating scales depending on uncertainty, computational priorities, and/or other factors. The RL agent can, in various embodiments, learn how cross-scale feedbacks influence intervention outcomes. Based on this understanding, the system can optimize where and/or when to deploy interventions (e.g., selecting between cloud-level microphysics manipulation and/or regional-scale aerosol dispersion).

According to a sixth such approach, adjoint and/or sensitivity-based coupling approaches can be used. According to this approach, adjoint models can compute sensitivity matrices that, for instance, link small perturbations in microscale variables (e.g., aerosol density and/or droplet number) to large-scale outcomes (e.g., storm trajectory and/or central pressure). These sensitivity fields can inform various parameters and/or processes of the system, such as model coupling weights and/or intervention optimization algorithms. In this way, benefits including ensuring that cross-scale coupling captures the nonlinear propagation of small interventions into macro-level weather effects can be realized.

According to a seventh such approach, temporal and/or spatial coupling strategies can be employed. Here, time synchronization mechanisms (e.g., asynchronous coupling and/or subcycling) can be used to allow models at different temporal resolutions to exchange data (e.g., to exchange data consistently). Further, spatial interpolation and/or projection schemes (e.g., spectral transforms, graph-based resampling, and/or tensor-based interpolation) can, in various embodiments, be used to ensure various outcomes including smooth transitions across grid resolutions (e.g., spatial grid resolutions). These strategies can provide various benefits including helping to maintain physical consistency while allowing variable time-step simulation speeds across the model hierarchy.

With reference to that which is discussed hereinabove, the system can implement various feedback and/or learning functionality. For example, the system can perform real-time monitoring of intervention effects. As another example, the system can support continuous model updating based on observed outcomes. As a further example, historical case analysis can be used by the system for strategy refinement. As an additional example, the system can perform adaptive optimization of intervention parameters, thereby, for instance, enabling the system to adjust its approach in response to changing conditions and/or new insights. As yet another example, the system can perform physics-based validation of intervention outcomes. As a further examples, the system can perform: a) microphysics parameter optimization; b) multi-scale model coupling refinement; and/or c) intervention delivery system calibration.

With reference to that which is discussed hereinabove, the system can implement various deep learning architecture, simulation framework, and/or control system functionalities. For example, the system can utilize transformer-based models for temporal sequence prediction (e.g., meteorological temporal sequence prediction). As just an example, the transformer architecture can be based on a vision-based transformer architecture, where a given cube in the atmosphere is projected onto an embedding space, allowing the transformer to identify local and/or remote dependencies between variables. The input and outputs for these models can, as just an example, be the full state of the atmosphere, such as including various state variables at various levels (e.g., all state variables at all levels). The models can operate in an auto-regressive manner, such that, as just an illustration, to predict weather at a future time (T+1), a given one of the models can be fed the state at time T, and to predict at T+10, the model can be looped on itself ten times, feeding output back as input.

Graph neural network models can, for example, be used by the system for spatial relationship modeling of different elements of a weather system, such as cold fronts, prevailing winds, and/or hurricane eye walls. In these models, the graph can, for example, be constructed by the system by representing atmospheric variables (e.g., pressure, temperature, humidity, and/or wind vectors) as nodes, and by establishing edges based on factors such as: a) spatial proximity; b) physical adjacency in the model grid; and/or c) dynamic relationships (e.g., derived from flow fields or correlation structures in meteorological data). The system can also employ multi-head attention mechanisms for feature importance weighting, and can support uncertainty quantification using PNNs. Further, neural operators and/or PINNs can be used by the system for learning and enforcement of physical constraints.

In terms of simulation frameworks, as just some examples the system can: a) implement parallel computing architectures for ensemble simulations; b) utilize GPU-accelerated numerical methods; c) apply adaptive mesh refinement for critical regions; d) incorporate multi-physics coupling mechanisms; and/or use ocean-air coupled models. As an example, the multi-physics coupling mechanisms and/or ocean-air coupled models can be implemented using AI-based surrogate frameworks in which neural operator networks learn the exchange dynamics of heat, momentum, and/or moisture across model boundaries. Here, an ocean-surface neural operator can, for instance, predict fluxes and/or boundary layer states conditioned on wave spectra and/or sea-surface temperature. Further here, an atmospheric neural operator (or another approach) can be used by the system to predict the corresponding response fields.

The two can, in various embodiments, be iteratively coupled, such as through differentiable interfaces. These differentiable interfaces can provide various benefits including ensuring physical consistency and enabling near real-time and/or bidirectional feedback between oceanic and atmospheric components, such as during intervention planning and simulation. Regarding control systems, as just some examples the system can implement: a) model predictive control (such as for intervention timing); b) robust control methods (such as for handling uncertainty); c) distributed control architectures (such as for coordinated interventions); and/or d) real-time optimization and adjustment capabilities.

Also with reference to that which is discussed hereinabove, the system can implement various distributed control architecture and/or data integration framework functionalities. For example, the system can implement a distributed control architecture that supports hierarchical control structures. In such an architecture, the system can operate at multiple levels, including a strategic level for global strategy, a tactical level for intervention execution, and/or an operational level for real-time adjustments. The system can also include redundant control nodes to enhance reliability, fault-tolerant communication protocols to ensure robust information exchange, and/or real-time decision support systems that can provide visualization (e.g., to support operational management). Regarding data integration, the system can, in various embodiments, employ: a) a multi-source data fusion architecture (e.g., to enable the integration of diverse data streams); b) a real-time processing pipeline; c) distributed sensor network integration; d) secure data transmission protocols; and/or e) automated quality control systems (e.g., to ensure the reliability of the data used for analysis and decision-making).

With further reference to that which is discussed hereinabove, the system can, in various embodiments, include and/or support a range of computing infrastructure elements, such as: a) high-performance computing clusters; b) distributed sensor networks; c) real-time data processing capabilities; and/or d) secure communication infrastructure. Also with reference to that which is discussed hereinabove, the system can, in various embodiments, incorporate and/or interface with a variety of physical systems, such as: a) intervention delivery platforms; b) sensor networks and/or monitoring systems; c) control and/or coordination centers; d) material production and/or storage facilities; and/or e) various equipment for conducting interventions, such as drones, crewed aircraft, boats, and/or large-scale assets. With additional reference to that which is discussed hereinabove, the system can, in various embodiments, be configured to address a range of regulatory considerations, such as: a) environmental impact assessments; b) international cooperation frameworks; c) safety and/or risk management protocols; and/or d) emergency response procedures.

As an illustration of using the system discussed herein, an example of an intervention to modify a hurricane will now be discussed. In an early detection phase, which can occur approximately seven to ten days prior to storm formation, the system can use global monitoring to detect favorable conditions for cyclonic development. Further at this phase, the system can use ensemble simulations to begin tracking potential formation scenarios, and/or deep learning models to analyze historical patterns and/or current conditions. Also during this phase, the system can initiate initial risk assessment and/or intervention planning.

In a formation confirmation phase, which can occur approximately five to seven days prior to storm formation, the system can confirm the presence of a tropical depression and/or similar event. Also at this phase, the system can initialize multi-scale models with current atmospheric conditions, and/or use ensemble simulations to generate trajectory probability distributions. Additionally at this phase, the system can identify initial intervention points (e.g., using chaos theory analysis), and/or develop and/or rank preliminary intervention strategies.

During a detailed planning phase, which can occur approximately three to five days prior to storm formation, the system can use microphysics models to analyze cloud structure and/or dynamics. Also at this phase, the system can run intervention optimization to evaluate multiple scenarios. Still further at this stage, the system can identify (e.g., identify optimal options for): a) timing windows for intervention; b) geographic locations for deployment; c) types and/or quantities of intervention materials; and/or d) delivery methods and platforms. Also at the detailed planning phase, the system can use reinforcement learning models to validate the effectiveness of candidate strategies.

In an intervention execution phase, which can occur approximately one to three days prior to storm formation, intervention assets can be positioned by the system based on a plan selected by the system (e.g., an optimal plan selected by the system). Also at this phase, the system can activate real-time monitoring, and/or can execute initial interventions (e.g., targeted cloud seeding). Still further at this stage, the system can monitor immediate effects, such as: a) cloud microphysics changes; b) convection patterns; c) eye wall stability; and/or d) moisture dynamics. Additionally at this stage, real-time adjustments can be made by the system based on observed responses.

During a continuous monitoring and adjustment phase, the system can: a) use multi-scale models to track intervention effects; b) adjust strategies based on observed outcomes; c) deploy secondary interventions (if needed); and/or f) continuously optimize intervention parameters as new data becomes available. In a resolution and analysis phase, the system can a) track final storm evolution; b) compare actual results to predicted outcomes; c) evaluate intervention effectiveness; and/or d) document actions taken and resultant outcomes. And, at a learning and optimization phase, the system can: a) update model parameters based on observed results; b) refine intervention strategies based on outcomes; c) enhance prediction accuracy using new data; and/or d) document lessons learned to inform future interventions.

The system discussed herein can provide a range of benefits including benefits across: a) humanitarian and financial; b) technical; and/or c) scientific domains. Turning to humanitarian and financial benefits, as just some examples the system can contribute to: a) reduced loss of life from tropical cyclone (e.g., hurricane) events; b) decreased property damage and/or economic losses; c) enhanced protection of critical infrastructure; and/or improved emergency response capabilities.

Turning to technical benefits, as just some examples the system can: a) enable more precise and/or effective tropical cyclone modification; b) support earlier intervention opportunities; c) reduce resource requirements (e.g., through optimal targeting); and/or d) achieve continuous system improvement through ongoing learning. And, turning to scientific benefits, as just some examples the system can: a) support advanced understanding of tropical cyclone dynamics; b) realize improved weather modeling capabilities; c) foster the development of improved intervention techniques; and/or d) cultivate an increased understanding of chaos theory applications (e.g., as applied to atmospheric science).

The functionality discussed herein can, in an aspect, be viewed as representing a significant advancement in the field of atmospheric intervention and/or weather modification, the first practical system for modifying tropical cyclones (e.g., hurricanes) and other large atmospheric phenomena. From a technical perspective, the functionality discussed herein can introduce numerous beneficial concepts and/or combinations for atmospheric science, including: a) the integration of multiple modeling scales and/or approaches; b) the use of AI for identifying intervention points (e.g., optimal intervention points) for weather modification; c) the application of chaos theory principles to intervention (e.g., minimal effective intervention); d) a continuous learning and/or optimization framework; e) multi-modal intervention strategy optimization; and f) real-time adaptation and/or adjustment capabilities.

The functionality discussed herein can be extended and/or adapted in a variety of ways. As just some examples the functionality can: a) be applied to weather phenomena beyond tropical cyclones and hurricanes; b) be integrated with various climate change mitigation strategies; c) be applied to extended prediction timeframes; d) be used in conjunction with enhanced intervention approaches; e) be used along with various international cooperation frameworks; and/or f) be applied in conjunction with various automated response systems.

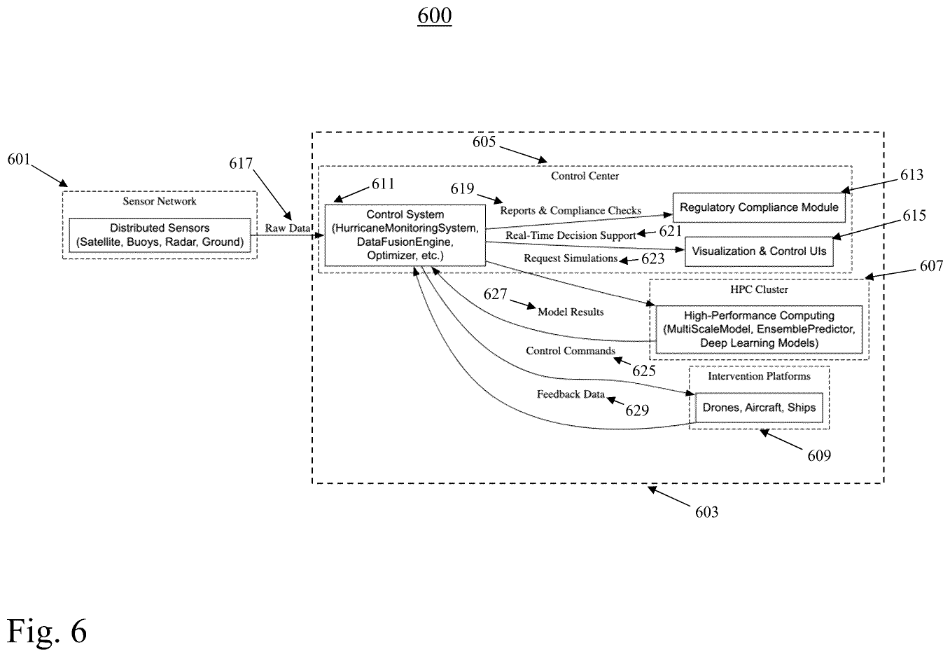

Turning to FIG. 6, it is noted that, in various embodiments, the functionality discussed herein can utilize a configuration 600 including sensor network 601 and prediction and modification elements 603. The sensor network 601 can, for example, include various distributed sensors such as satellites, buoys, radar, and/or ground stations. The prediction and modification elements 603 can, for example, include control center 605, high-performance computing (HPC) cluster 607, and/or intervention platforms 609.

The control center 605 can include control system 611, regulatory compliance module 613, and visual and control user interfaces 615. The control system 611 can regard, as just some examples: a) global monitoring to detect favorable conditions for cyclonic development (shown as “HurricaneMonitoringSystem” in the figure); b) data integration, such as via multi-source data fusion architecture (shown as “DataFusionEngine” in the figure); and/or c) intervention optimization (shown as “Optimizer” in the figure). The regulatory compliance module 613 can regard, for example, operations that act to help ensure that selected interventions do not violate various regulations. The visual and control user interfaces 615 can, in an aspect, provide interfaces for users to monitor system status, view data, and/or interact with and/or adjust system operations. The HPC cluster 607 can regard, as just some examples: a) multi-scale modeling frameworks (shown as “MultiScaleModel” in the figure); b) ensemble-based prediction frameworks that generate potential trajectory scenarios (shown as “EnsemblePredictor” in the figure); and/or c) deep learning models such as those discussed herein. As also depicted by the figure, intervention platforms 609 can regard, as just some examples, drones, aircraft, and/or ships.

As further depicted by the figure, the control system 611 can send various messages. As just some examples, the control system 611 can send: a) reports and/or compliance check messages 619 to regulatory compliance module 613; b) real-time decision support messages 621 to visual and control user interfaces 615; c) simulation request messages 623 to HPC cluster 607, and/or d) control command messages 625 to intervention platforms 609. As additionally depicted by the figure, the control system 611 can receive various messages. As just some examples, the control system 611 can receive: a) raw data 617 from sensor network 601; b) model results 627 from HPC cluster 607; and/or c) feedback data 629 from intervention platforms 609.

### Hardware and Software

According to various embodiments, various functionality discussed herein can be performed by and/or with the help of one or more computers. Such a computer can be and/or incorporate, as just some examples, a personal computer, a server, a smartphone, a system-on-a-chip, and/or a microcontroller. Such a computer can, in various embodiments, run Linux, MacOS, Windows, or another operating system.

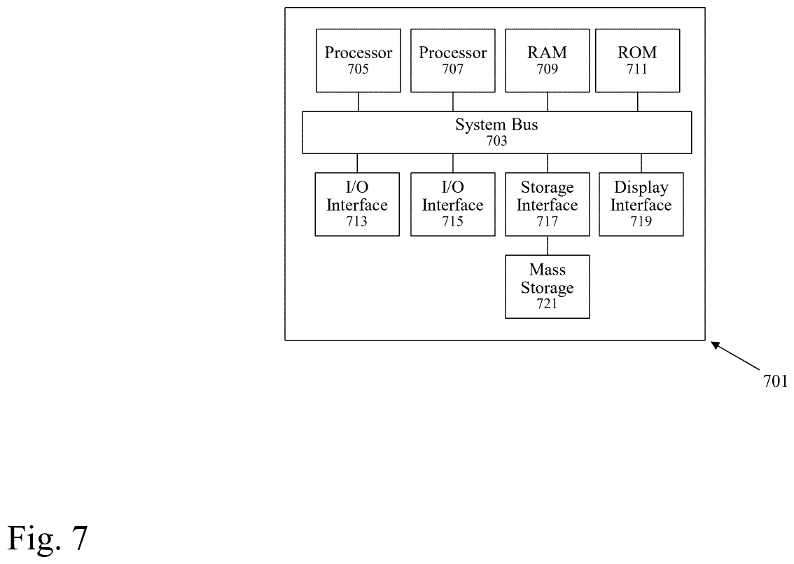

Such a computer can also be and/or incorporate one or more processors operatively connected to one or more memory or storage units, wherein the memory or storage may contain data, algorithms, and/or program code, and the processor or processors may execute the program code and/or manipulate the program code, data, and/or algorithms. Shown in FIG. 7 is an example computer employable in various embodiments of the present invention. Example computer 701 includes system bus 703 which operatively connects two processors 705 and 707, random access memory (RAM) 709, read-only memory (ROM) 711, input output (I/O) interfaces 713 and 715, storage interface 717, and display interface 719. Storage interface 717 in turn connects to mass storage 721. Each of I/O interfaces 713 and 715 can, as just some examples, be a Universal Serial Bus (USB), a Thunderbolt, an Ethernet, a Bluetooth, a Long-Term Evolution (LTE), a 5G, an IEEE 488, and/or other interface. Mass storage 721 can be a flash drive, a hard drive, an optical drive, or a memory chip, as just some possibilities. Processors 705 and 707 can each be, as just some examples, a processor such as an ARM-based processor, an x86-based processor, a graphics processing unit (GPU) (e.g., an Nvidia Blackwell), and/or a systolic processor. Computer 701 can, in various embodiments, include or be connected to a touch screen, a mouse, and/or a keyboard. Computer 701 can additionally include or be attached to card readers, DVD drives, floppy disk drives, hard drives, memory cards, ROM, and/or the like whereby media containing program code (e.g., for performing various operations and/or the like described herein) may be inserted for the purpose of loading the code onto the computer.

In accordance with various embodiments of the present invention, a computer may run one or more software modules designed to perform one or more of the above-described operations. Such modules can, for example, be programmed using Python, Java, JavaScript, Swift, C, C++, C#, and/or another language, and/or can be constructed using frameworks such as LangChain and/or through prompt engineering approaches. Corresponding program code can be placed on media such as, for example, DVD, CD-ROM, memory card, and/or floppy disk. It is noted that any indicated division of operations among particular software modules is for purposes of illustration, and that alternate divisions of operation may be employed. Accordingly, any operations indicated as being performed by one software module can instead be performed by a plurality of software modules. Similarly, any operations indicated as being performed by a plurality of modules can instead be performed by a single module. It is noted that operations indicated as being performed by a particular computer can instead be performed by a plurality of computers. It is further noted that, in various embodiments, peer-to-peer and/or grid computing techniques may be employed. It is additionally noted that, in various embodiments, remote communication among software modules may occur. Such remote communication can, for example, involve JavaScript Object Notation-Remote Procedure Call (JSON-RPC), Simple Object Access Protocol (SOAP), Java Messaging Service (JMS), Remote Method Invocation (RMI), Remote Procedure Call (RPC), sockets, and/or pipes.

Moreover, in various embodiments the functionality discussed herein can be implemented using special-purpose circuitry, such as via one or more integrated circuits, Application Specific Integrated Circuits (ASICs), or Field Programmable Gate Arrays (FPGAs). A Hardware Description Language (HDL) can, in various embodiments, be employed in instantiating the functionality discussed herein. Such an HDL can, as just some examples, be Verilog or Very High Speed Integrated Circuit Hardware Description Language (VHDL). More generally, various embodiments can be implemented using hardwired circuitry without or without software instructions. As such, the functionality discussed herein is limited neither to any specific combination of hardware circuitry and software, nor to any particular source for the instructions executed by the data processing system.

### Ramifications and Scope

Although the description above contains many specifics, these are merely provided to illustrate the invention and should not be construed as limitations of the invention's scope. Thus, it will be apparent to those skilled in the art that various modifications and variations can be made in the system and processes of the present invention without departing from the spirit or scope of the invention.

In addition, the embodiments, features, methods, systems, and details of the invention that are described above in the application may be combined separately or in any combination to create or describe new embodiments of the invention.

1. A computer-implemented method, comprising:
receiving, by a computing system, environmental sensor data;
analyzing, by the computing system using one or more first machine learning models, the environmental sensor data, wherein one or more atmospheric phenomena are identified; and
generating, by the computing system, using one or more further machine learning models, one or more interventional weather modification strategies.

2. The computer-implemented method of claim 1, further comprising:
combining, by the computing system, machine learning models operating at different physical scales.

3. The computer-implemented method of claim 1, further comprising:
initiating, by the computing system, one or more atmospheric physical interventions.

4. The computer-implemented method of claim 1, further comprising:
optimizing, by the computing system using one or more reinforcement learning models, one or more of said interventional weather modification strategies.

5. The computer-implemented method of claim 1, further comprising:
identifying, by the computing system using differential evolution, one or more atmospheric intervention points.

6. The computer-implemented method of claim 1, further comprising:
generating, by the computing system using ensemble-based machine learning, one or more trajectory scenarios for one or more of said atmospheric phenomena.

7. The computer-implemented method of claim 1, further comprising:
varying, by the computing system using one or more counterfactual what-if machine learning model ensembles, one or more intervention-specific control parameters.

8. The computer-implemented method of claim 1, further comprising:
performing, by the computing system, a rewards-based evaluation of one or more candidate intervention strategies.

9. The computer-implemented method of claim 1, further comprising:
tracking, by the computing system using one or more machine learning models, one or more intervention effects; and
adjusting, by the computing system, one or more of the interventional weather modification strategies.

10. The computer-implemented method of claim 1, further comprising:
ensuring, by the computing system using constraint satisfaction, that said interventional weather modification strategies satisfy one or more of regulatory, weather worsening, or ecological impact constraints.

11. A system, comprising:
at least one processor; and
a memory storing instructions that, when executed by the at least one processor, cause the system to perform:
receiving environmental sensor data;
analyzing, using one or more first machine learning models, the environmental sensor data, wherein one or more atmospheric phenomena are identified; and
generating, using one or more further machine learning models, one or more interventional weather modification strategies.

12. The system of claim 11, wherein the instructions, when executed by the at least one processor, further cause the system to perform:
optimizing, using one or more reinforcement learning models, one or more of said interventional weather modification strategies.

13. The system of claim 11, wherein the instructions, when executed by the at least one processor, further cause the system to perform:
identifying, using differential evolution, one or more atmospheric intervention points.

14. The system of claim 11, wherein the instructions, when executed by the at least one processor, further cause the system to perform:
varying, using one or more counterfactual what-if machine learning model ensembles, one or more intervention-specific control parameters.

15. The system of claim 11, wherein the instructions, when executed by the at least one processor, further cause the system to perform:
tracking, using one or more machine learning models, one or more intervention effects; and
adjusting one or more of the interventional weather modification strategies.

16. A non-transitory computer-readable storage medium including instructions that, when executed by at least one processor of a computing system, cause the computing system to perform a method, comprising:
receiving environmental sensor data;
analyzing, using one or more first machine learning models, the environmental sensor data, wherein one or more atmospheric phenomena are identified; and
generating, using one or more further machine learning models, one or more interventional weather modification strategies.

17. The non-transitory computer-readable storage medium of claim 16, wherein the instructions, when executed by the at least one processor, further cause the computing system to perform:
optimizing, using one or more reinforcement learning models, one or more of said interventional weather modification strategies.

18. The non-transitory computer-readable storage medium of claim 16, wherein the instructions, when executed by the at least one processor, further cause the computing system to perform:
identifying, using differential evolution, one or more atmospheric intervention points.

19. The non-transitory computer-readable storage medium of claim 16, wherein the instructions, when executed by the at least one processor, further cause the computing system to perform:
varying, using one or more counterfactual what-if machine learning model ensembles, one or more intervention-specific control parameters.

20. The non-transitory computer-readable storage medium of claim 16, wherein the instructions, when executed by the at least one processor, further cause the computing system to perform:
tracking, using one or more machine learning models, one or more intervention effects; and
adjusting one or more of the interventional weather modification strategies.
